(19) United States
(12) Patent Application Publication
(10) Pub. No.: US 2008/0031107 A1
(43) Pub. Date: Feb. 7, 2008

(54) Optical disk apparatus and a method for compensating recording power of the same

(75) Inventors: Tomoya Hoshi, Fujisawa (JP); Mitsuhiro Nishidate, Sagamihara (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi-LG Data Storage, Inc., Tokyo (JP)

(21) Appl. No.: 11/703,035

(22) Filed: Feb. 5, 2007

(30) Foreign Application Priority Data
Aug. 2, 2006 (JP) 2006-210640

(51) Int. Cl. G11B 7/00

(52) U.S. Cl. 369/47.5; 369/44.11

(57) ABSTRACT

For providing a method for conducting a real-time compensation on the recording power during that verify process, and also for providing an optical disk apparatus for achieving the high-speed recording of information and the high quality, by adopting such the method therein, the method for compensating a recording power of an optical disk apparatus, for recording/reproducing information onto/from an optical disk 100, which forms a track made of spiral-like land and groove on a information recording surface thereof, and is executed with a verify process for a defect block within a user data recording area thereof, wherein when executing a verify process, error information of data, which is written by a light irradiated from an optical pickup 200, is obtained from a reproduced signal, which is reproduced from said optical pickup, and an intensity of the light irradiated from a laser light source of said optical pickup, upon basis of a β value, which is obtained by a β value detecting means 240, as well as, the error information, which are detected when executing the verify process.

### BACKGROUND OF THE INVENTION

The present invention relates to a disk recording/reproducing apparatus for recording or reproducing information onto/from a disc-like optical recording medium, such as, CD and/or DVD, etc. (hereinafter, being called an “optical disk”), and it relates a method for compensating recoding power, in particular, for achieving high-speed recording and also maintaining recording quality thereof to be high, and further an optical disk apparatus for achieving the high-speed recording and the high recording quality by applying such the method therein.

An optical disk apparatus for recording or reproducing various kinds of information onto/from a recording medium, i.e., an optical disk, such as, a CD and/or a DVD, etc., for example, representatively, is widely used as an information recording apparatus within various kinds of electronic apparatuses including, such as, a personal computer, etc. In particular, in recent years, various kinds of DVDs are spread or popularized widely, in addition to the conventional CDs, and further a HD-DVD and/or a BD, each being a recording medium having a large memory capacity, is/are under the commercialization thereof. Accompanying with this, there is required a disk recording/reproducing apparatus being enable with such various kinds of optical disks.

In particular, upon a recording medium having large memory capacity, such as, DVD and/or BD, accompanying with an increase of a volume of information recorded on the medium, for maintaining a reliability (high recording quality) against disk defects when recording information thereon, so-called a verify process is conducted, i.e., testing coincidence with the original data, while reading out the user data by a predetermined block unit, one after another, while recoding it thereon. If determination is made that they are not coincident with, as a result of this verify process, that block is recognized to be a defect block, and also, it is necessary to conduct a process, so-called an alternation process, i.e., recording it in an area or region (i.e., an alternation area) different from the user data recording area on the optical disk.

On the other hand, for example, for rewritable-type disks, such as, so-called a DVD-R and DVD-RW, etc., there is already known a method for compensating the recording against deterioration on local recording characteristics on the information recording surface of the disk, due to the following reasons; such as, changes of recording speed depending on the position upon the optical disk surface, further a warp or a curve on the disc-like optical disk surface, as well as, non-uniformity on sensitivity (i.e., inequality of sensitivity) on the optical disk surface, etc., in the following Patent Documents 1 and 2.

Thus, the Patent Document 1 discloses therein a method for conducting compensating on a laser power, in particular, when achieving the CAV recording under a constant rotation angle, while dividing the recording area on the optical disk is into plural numbers, in a radial direction thereof, to be set up, wherein reproduction is made at a terminal portion of an area, on which the recording is already completed (hereinafter, being called “recorded area”, at each dividing position, when recording, so as to evaluate an asymmetry of RF signal for a pigment disk, such as, DVD-R or the like, or a modulation factor or degree of RF signal for the phase-change disk, such as, DVD-RW or the like. Also, the Patent Document 2 discloses therein a method for conducting compensation on the laser power, in particular, when achieving the ZCLV recording of controlling a linear velocity to be constant for each zone, wherein the recording is stopped once when exchanging the rotation speed of the optical disk, so as to reproduce the terminal portion of the recorded area, and thereby measuring β value of the RF signal.

Further, as a means for evaluating the recording quality for the purpose of carrying out such the recording compensation as was mentioned, in the following Patent Document 3, there is already disclosed a method for conducting the laser power compensation, in case where a PI error value exceeds a permissible value when conducting a recording test on management data recorded in a record management area, after setting up an optimal recording power in a testing area for writing on the DVD-RW. And, in the following Patent Document 4 is disclosed a method, wherein recording is stopped once, so as to reproduce the terminal portion of the recorded area, in particular, on DVD+R, DVD+RW, thereby conducting a laser power compensation with using a reflection rate, as well as, the β value of the RF signal.

[Patent Document 1] Japanese Patent Laying-Open No. 2002-208139 (2002);

[Patent Document 2] Japanese Patent Laying-Open No. 2005-92950 (2005);

[Patent Document 3] Japanese Patent Laying-Open No. 2004-206803 (2004); and

[Patent Document 4] Japanese Patent Laying-Open No. 2005-116027 (2005).

### BRIEF SUMMARY OF THE INVENTION

However, with such the conventional arts as mentioned above, there are descriptions about the recording compensation method relating to the information recording media, such as, the above-mentioned DVD-R and DVD-RE, etc., and also means for evaluating the recording quality thereof; however, there is still no mentioning about a method for enabling the compensation on the recording power, for the purpose of keeping the recording quality to be high, in particular, in relation to the DVD-RAM, accompanying or requiring the verify process so as to maintain the reliability (i.e., high quality) mentioned above, as well as, recording data onto both, the Land and the Groove, each being formed spirally on the recording surface thereof.

Thus, on the optical disk, such as, DVD-RAM, etc., accompanying with an advancement of high-speed recording thereof, so-called the verify process is adopted, for maintaining the reliability (the high quality) against the defect block during when recording thereon, i.e., after completing recording operation onto a predetermined area, reproduction is made on that area, so as to conduct an alternation process when recording is failed, and thereby maintaining the recording quality. However, only by means of such the verify process, a tolerance for maintaining the recording quality is reduced, and therefore, it is necessary to add a further other recording compensation method. However, none of such the conventional technologies, as mentioned above, provides a method or a means for achieving the recording power compensation, through real-time obtaining of the information.

Then, according to the present invention, in particular, within the optical disk apparatus enabling to record/reproduce information also onto/from an optical information recording medium (the optical disk), adopting the so-called the verify process therein, for recording data onto both the Land and the Groove, as well as, maintaining the high-speed recording and the reliability (high quality), an object thereof is to provided a method for conducting a real-time compensation on the recording power during that verify process, for the purpose of achieving the high-speed recording of information and also the high quality, and further an optical disk apparatus for achieving the high-speed recording of information and the high quality, by adopting such the method therein.

According to the present invention, for accomplishing such the object as was mentioned above, there is provided an optical disk apparatus, for recording/reproducing information onto/from an optical disk, which forms a track made of spiral-like land and groove on a information recording surface thereof, and is executed with a verify process for a defect block within a user data recording area thereof, comprising: a disk motor, which is configured to rotationally drive the optical disk; a disk motor driver circuit, which is configured to drive said disk motor; an optical pickup, which is configured to have a laser light source, for irradiating a light upon the recording surface of said optical disk being rotationally driven by said disk motor, and to receive a reflection light thereupon, and thereby recording or reproducing data on the recording surface of said optical disk; a laser driver circuit, which is configure to drive the laser light source of said optical pickup; a slide motor, which is configured to move said optical pickup into a radial direction on said optical disk; a β value detector circuit, which is configured to detect a β value to determine an intensity of the light irradiated from said optical pickup; and a controller, which is configured to control at least said disk motor driver circuit, said slide motor driver circuit and said laser driver circuit, upon basis of a signal from said optical pickup and said β value detector circuit, wherein said controller obtains error information of the data, which is written by the light irradiated from said optical pickup, from a reproduced signal, which is reproduced by said optical pickup, and also compensates the intensity of the light irradiated from the laser light source of said optical pickup, upon basis of the β value and the error information, which are detected when a verify process is conducted.

Also, according to the present invention, for accomplishing the object mentioned above, there is provided a method for compensating a recording power of an optical disk apparatus, for recording/reproducing information onto/from an optical disk, which forms a track made of spiral-like land and groove on a information recording surface thereof, and is executed with a verify process for a defect block within a user data recording area thereof, wherein when executing a verify process, error information of data, which is written by a light irradiated, is obtained from a reproduced signal, which is reproduced from said optical pickup, and an intensity of the light irradiated from a laser light source of said optical pickup, upon basis of a β value and the error information, which are detected when executing said verify process.

Further, according to the present invention, within the optical disk apparatus or the method for compensating a recording power thereof, it is preferable that said β value and said error information are obtained for each of said land and said groove, respectively, and the intensity of the light irradiated from the laser light source of said optical pickup is compensated for each of said land and said groove, respectively, or statistic information thereof is obtained from said β value obtained, and the intensity of the light, which is irradiated from the laser light source of said optical pickup is compensated, upon basis of said statistic information. Further, it is also preferable that said statistic information is obtained through an averaging process of the β value obtained, or the intensity of the light, which is irradiated from the laser light source of said optical pickup, is compensated, by changing said β value.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a perspective view for showing the entire structures of an optical disk apparatus, according to an embodiment of the present invention;

FIGS. 2(A) and 2(B) are views for showing the arrangement of alternation area(s), on an optical disk, which can be loaded into the optical disk apparatus mentioned above;

FIG. 3 is a view for showing the arrangement structures of data including an alternation area on the optical disk;

FIG. 4 is a flowchart for showing an outline of writing process conducted within the optical disk apparatus mentioned above; and

FIG. 5 is a flowchart for showing the details of processes for obtaining statistic information and changing are cording power, within the writing process shown in FIG. 4 mentioned above.

### DETAILED DESCRIPTION OF THE INVENTION

Hereinafter, embodiments according to the present invention will be fully explained by referring to the attached drawings.

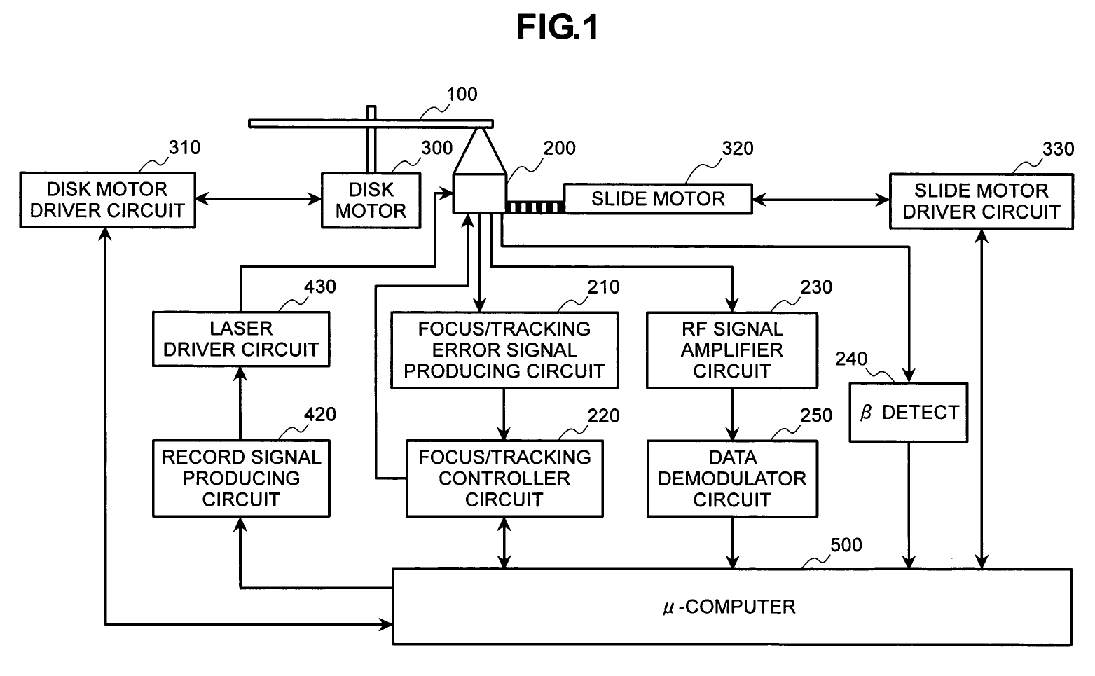

First of all, FIG. 1 attached herewith shows briefly therein the inner structures of an optical disk apparatus, according to an embodiment of the present invention, wherein a reference numeral 100 depicts so-called a disc-like optical recording medium (i.e., an optical disk), such as, DVD-RAM or the like, for example, which is loaded into that optical disk apparatus to be conducted with recording or reproducing of information thereon/from.

Also, a reference numeral 300 in this figure depicts a disk motor for rotationally driving the optical disk 100 mentioned above, and as apparent in this figure, on a turntable (not shown in the figure) attached at a tip of a rotation shaft thereof is loaded the above-mentioned optical disk 100, and thereby rotationally driving that optical disk, at a desired rotation speed. Further, this disk motor 300 is driven through a disk motor driver circuit 310, as a driving means thereof. Thus, the optical disk 100 loaded on the turntable of the disk motor 300 is controlled in the rotation speed thereof, appropriately, through the disk motor driver circuit 310, for example, in accordance with the known constant angular velocity (CAV) method or constant liner velocity (CLV) method.

Next, a reference numeral 200 in the figure depicts so-called an optical pickup, being attached to be movable in a radial direction of the optical disk 100 mentioned above, for irradiating a laser beam onto the recording surface thereof, and thereby receiving the laser beam reflected from that recording surface. Further, within an inside of this optical pickup 200, although not mentioned in the details thereof, herein, but an electric signal is reproduced from the above-mentioned laser beam reflected, and this reproduced signal is outputted into a focus tracking error signal producing circuit 210, and upon basis of that signal, a focus error signal and/or a tracking error signal is/are produced therein, for example. And, upon basis of the focus error signal and/or the tracking error signal outputted from this focus tracking error signal producing circuit 210, a focus/tracking controller circuit 220 forms a control signal to be inputted into the optical pickup 200 mentioned above, and thereby controlling the position of an objective lens (not shown in the figure), which is provided to be movable within the optical pickup 200.

Further, it is also same to the conventional art that a laser diode (not shown in the figure), as a laser beam source, which is provided within an inside of the optical pickup 200 mentioned above, is driven and also controlled in light emission intensity thereof, trough a laser driver circuit 430, for supplying driving current, upon an output of a record signal producing circuit 420, which produces a record signal shown in the figure. Also, in a part of the optical pickup 200 mentioned above is provided a photo-detector element, such as, a photo-diode or a photo-transistor or the like, thereby observing a part of the laser beam emitted from the laser diode, as a laser light source (i.e., a power control monitor). And, an actual β value can be detected by means of this power control monitor, and it is outputted through a β value detector means 240 shown in the figure.

Also, among electric signals, which are reproduced from the reflected laser beam within the optical pickup 200 mentioned above, so-called a RF signal is transferred into a RF signal amplifier circuit 230 for processing that RF signal to be amplified, and further it is outputted into a data demodulator circuit 250 for processing that amplified RF signal to be demodulated.

Further, within the optical pickup 200 mentioned above, there is attached a slide motor 320 for moving that optical pickup into the radial direction of the optical disk 100, and this slide motor 320 is driven/controlled through a slide motor driver circuit 330 for controlling/driving this. And, in this figure, a reference numeral 500 depicts a controller means for controlling the above-mentioned disk motor driver circuit 310, the record signal producing circuit 420, the focus/tracking controller circuit 220, and the slide motor driver circuit 330, etc., and this is constructed with a micro (μ)-computer, for example, having a buffer memory (not shown in the figure) in a part thereof.

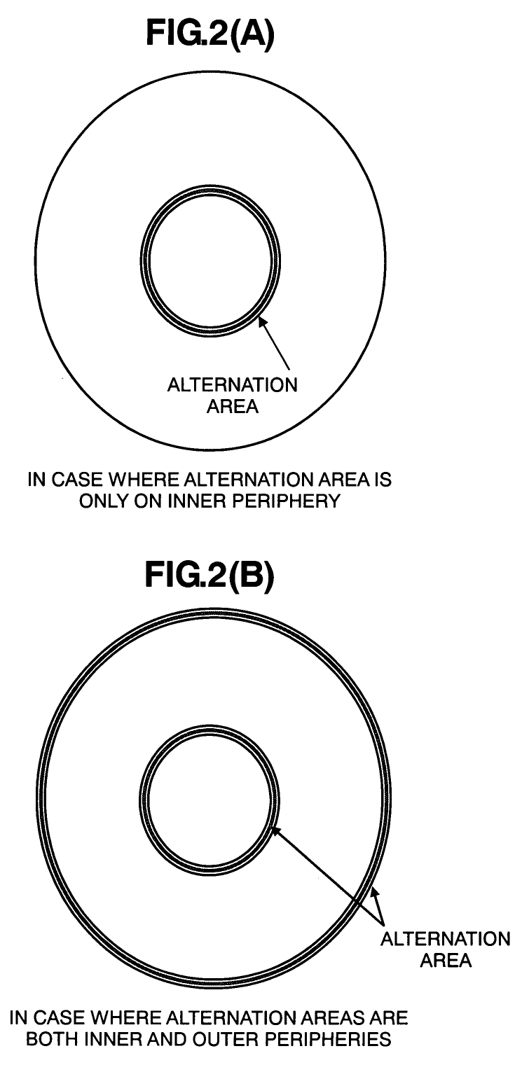

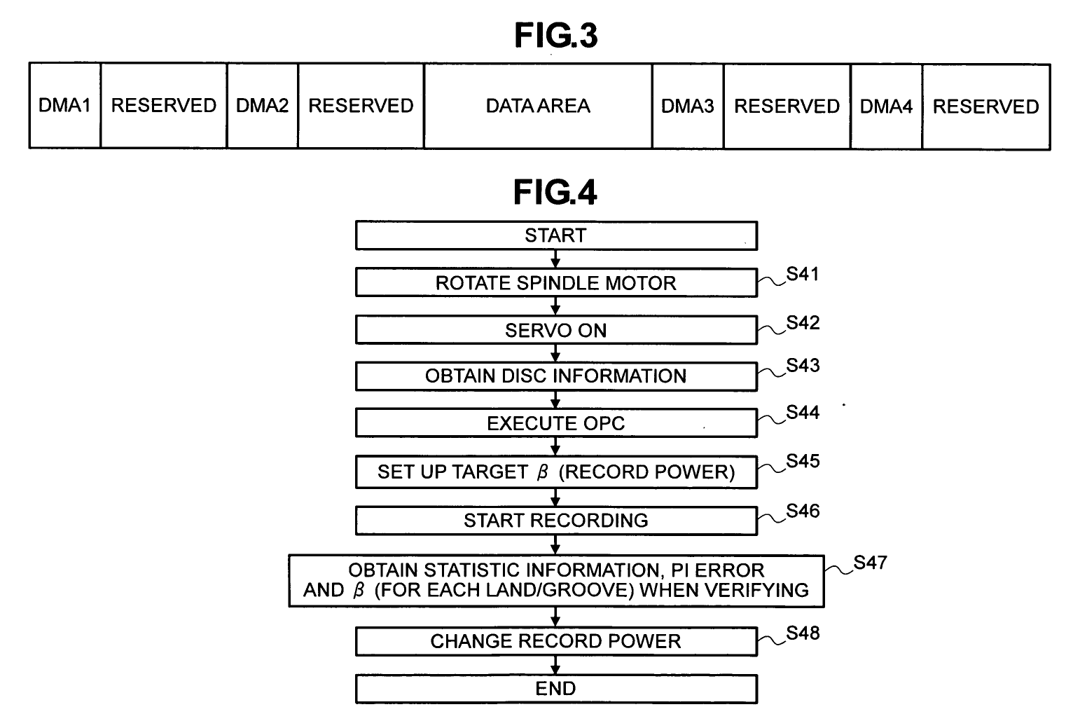

On the other hand, upon the optical disk 100 is executed so-called the verify process, for the purpose of maintaining the reliability of recording (high quality) against disk defects, which are caused due to adhesion of finger prints or scratches on the recording surface thereof, for example. In that instance, the data recorded once is read out by unit of a predetermined block (for example, by a unit of 1ECC), and is compared with the data to be recorded, which in stored into the memory within the apparatus from an outside thereof. Further, in this instance, comparison between the data, which is reproduced after having being recorded once, and the data to be recorded, which is stored within the memory, enables to obtain an PI error (readout error rate) information. And, if inconsistency (i.e., defect) is found, as a result of the comparison, so-called the alternation process is conducted, of recording the said information to be recorded onto a destination of alternation (i.e., an alternation area), such as, the position separate from the an origin of the alternation. In that case, as shown in FIGS. 2(A) and 2(B), the optical disk comprises the alternation area at the innermost periphery position, or the alternation areas at the innermost and the outermost positions, on the information recording surface thereof, and also so-called a data recording area between those areas provided at the innermost and the outermost sides, where a user can record data therein. And, as is shown in FIG. 3, in each of said alternation areas, there are provided the alternation area for writing the alternation data of the defect block therein, and also a DMA area for writing the address information of it therein. In more details thereof, there are provided two (2) pieces of DMA areas and reserved areas, respectively, such as, DMA1 and DMA2 on the inner periphery side, and DMA1 and DMA2 on the inner periphery side.

Following to the above, in the structures mentioned above, for example, recording of the user data (information) is conducted while shifting the optical pickup 200 from the inner periphery side towards the outer periphery side on the optical disk 100. In more details, the microcomputer 500 mentioned above executes it while making the disk motor 300 rotate at a predetermined speed (a double-speed) or in accordance with the method (i.e., CAV or CLV, etc.) through the disk motor driver circuit 310.

Namely, within the user data recording area on the optical disk 100 mentioned above, the user data is recorded appropriately, through conducting the recording operation under the predetermined double-speed, on the other hand, that data recorded is read out, by a unit of one (1) piece or a plural number of pieces of blocks, one after another, to be tested on the coincidence with the original data (i.e., a verify process). If it is determined that those data are not same nor coincident with, as a result thereof, the said block is recognized to be the defect block, and then the microcomputer 500 executes the control for the alternation process, upon basis of that detection result. In more details thereof, the microcomputer 500 moves the optical pickup 200, trough the slide motor driver circuit 330 and the slide motor mentioned above, to the alternation area on the outermost periphery side or the innermost periphery side of the disk, thereby writing the defect block into the said alternation area, as well as, writing the address information thereof into the DMA area therein.

According to the present invention, a real-time β value (i.e., a numerical value relating to depth of pits formed on the optical disk) and real-time PI error (readout error rate) information are obtained during execution of the writing process (see FIG. 4), which will be mentioned below, and a real-time compensation is executed on the recording power, upon basis of statistic information, thereby obtaining an optimal recording quality. Further, in this instance, the β value mentioned above can be detected by means of the power control monitor made of the photo-detector element, such as, a photo-diode or a photo-transistor, etc., for example, which is provided in a part of the optical pickup 200, and it can be obtained from the β value detector means 240 mentioned above.

However, in the present invention, determination is made between Land/Groove, upon basis of address information during the time of the verify process, and thereby obtaining the PI error, and the β value per the unit of 1ECC, for each of Land/Groove. And, the alternation process is executed when either the PI error information or the β value obtained exceeds a threshold value, on the other hand, when the PI error information or the β value is within the threshold value, then compensation is made upon the recording power so that the PI error information and the β value per the unit of 1ECC come close to the reference values thereof.

In FIG. 4 attached here with is shown an outline of the writing operation to be executed within the optical disk apparatus, the structures of which were explained in the above. When loading so-called the disc-like optical recording medium (i.e., the optical disk), such as, the DVD-RAM, etc., mentioned above, into the apparatus (in more details, onto the turntable of the spindle motor 300), the spindle motor 300 is driven, rotationally (S41), and following this, a tracking focus servo of the optical pickup 200 is turned into ON condition thereof (S42). Thus, with this, the optical pickup 200 can move into the radial direction of the disk, and thereby conducting recording/reproducing of data (including the user data) onto/from the recording surface, through irradiating the laser beam for use of writing on that information recording surface of the disk.

Next, while rotating the optical disk 100 loaded onto the spindle motor 300 mentioned above at the predetermine rotation speed, so-called a DISC information is obtained (S43), being a unique information of that optical disk loaded, which is provided at the innermost periphery side thereof. And, upon basis of this DISC information obtained, an OPC (Optimum Power Control) is executed (S44) for setting an output of the laser beam for writing at the optimum value within the optical pickup 200 mentioned above, and further setup is made of a target value of β (i.e., Target β) (S45), for determining the PI, i.e., an optimal recording power (Recording Power). Thereafter, recording of data is started (S46). Thus, upon execution of the OPC mentioned above, an initial value of recording power is detected, and further, upon basis of this initial recording power value, the recording operation is started.

However, in this recording operation, although the so-called verify process is executed, for testing a coincidence or consistency between the original data, by reading it out per the predetermined unit of blocks (for example, by the unit of 1ECC), one after another, while recording the user data onto the user area, however according to the present invention, the PI error value and the β value are obtained (but, separately, between Land and Groove) at the time when verifying after the writing operation, so as to obtain the statistic information (S47). However, this statistic information is that, which can be obtained by calculating an averaged value between the value obtained in the past, every time when the β value can be obtained, for example. Thereafter, the recording power (Recording Power) is altered (S48), and a series of steps is completed.

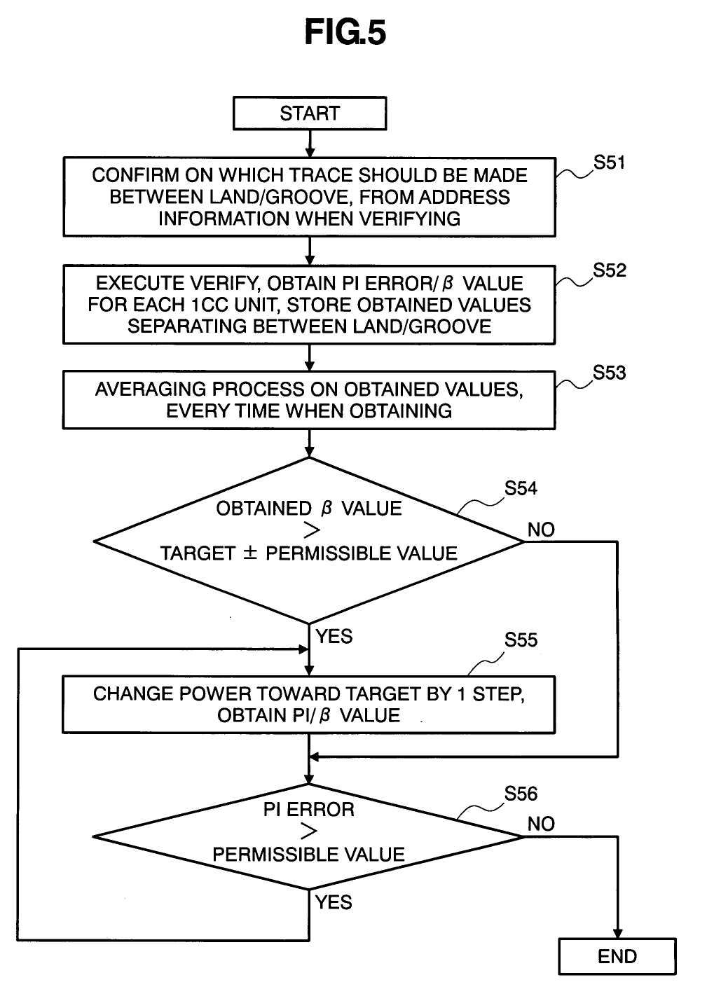

Further, in FIG. 5 attached here with is shown, in particular, the details within the processes of obtaining statistic information (S47) and of changing the recording power (S48), to which the present invention relates. Thus, when starting the process, confirmation is made on whether the position of conducting the writing operation (i.e., the track) is Land or Groove (S51), from the address information when executing the verify operation after the writing operation mentioned above. Thereafter, while executing the verify process, and at the same time, the PI error value and the β value are obtained, per the unit of 1ECC, and those values obtained are stored within the memory of the microcomputer (S52), for example, separately into Land or Groove. However, in this instance, since it can be seen on which track, between Land and Groove, the verify operation is executed; therefore it is possible to store the obtained values separating between Land and Groove, respectively.

Thereafter, upon the β value obtained in the above is conducted the so-called averaging process (S53). However, also this process is executed, separating between Land and Groove, respectively, and is executed every time when the β value is obtained. However, this averaging process is not always necessary, but also the β value obtained may be used as it is. As such the averaging process, it is also possible to apply a weighing process therein, and it is also possible to apply a heavy weight onto newest data, thereby reflecting the newest data much more.

Following to the above, determination is made on whether the β value obtained in the above is within a permissible range or not (S54). In more details thereof, the β value obtained is compared with a target value (i.e., Target β)±the permissible value. As a result, when it is determined that the value is greater than the target value (Target β)±the permissible value (“Yes”: i.e., exceeding the region of permissible value), then alternation is made on the recording power (Recording Power) (S55). In more details, the β value is changed, gradually, by one (1) step, towards the target value (Target β). In this instance, at the same time, the PI error value and the β value are obtained, through executing the writing operation, again, with the recording power (Recording Power) that is determined by using said β value changed. And, the PI error value obtained in the above is compared with the permissible value (S56).

On the other hand, the β value is less than the target value (Target β)±the permissible value (“No”: i.e., within the region of permissible value), then the PI error value is compared with the permissible value (S56), but without executing the alternation of the recording power (Recording Power) (S55). And, as a result of the comparison (S56), when determination is made that the PI error value does not exceed the permissible value (“No”), a series of the steps is completed. On the other hand, when determination is made that the PI error value exceeds the permissible value (“Yes”), then the process turns back to the step S55, so as to change the recording power (Recording Power), as well as, to obtain the PI error value and the β value, again, thereby comparing the PI error value with the permissible value (S56). Thus, this operation is repeated until when it is determined that the PI error value does not exceed the permissible value (“No”). Further, an adjusting (or alternating) operation of the β value including the target value (i.e., Target β) mentioned above, it is also executed, dividing it into Land or Groove, respectively, in the similar manner to the above-mentioned. Also, in particular, the recording power is compensated in a step-wise manner, upon basis of the PI error value and the β value per each ECC unit, which can be obtained through the verify process, so that the recording power comes close to the reference β value; i.e., by averaging the PI error value and the β value within each ECC unit, as well as, obtaining the statistic information of the PI error value and the β value between each ECC.

Namely, as apparent from the explanation given in the above, with the optical disk apparatus, according to one embodiment of the present invention, during when executing the writing process thereof (see FIG. 3), it is possible to obtain the β value necessary for executing the compensation on the recording power, or the PI error (i.e., the reading error rate), together with the statistic information thereof, simultaneously or in a real-time manner, with using the time when executing the verify process therein, in particular, upon the optical information recording medium (i.e., the optical disk) recording data on both Land and Groove, like the DVD-RAM, for example, and regulating (or standardizing) the so-called verify process thereon, for maintaining the high recording-speed and the reliability (high quality), and upon basis of the value obtained or the statistic information thereof, or further the PI error (i.e., the reading error rate), it is also possible to compensate the recording power, preferably, in the real-time manner and for each ECC unit, thereby obtaining the optimal recording quality.

Thus, as apparent from the above mentioned, according to the present invention, there can be achieved a superior effect of providing the method for conducting a real-time compensation on the recording power during that verify process, for the purpose of achieving the high-speed recording of information and also the high quality, and further the optical disk apparatus for achieving the high-speed recording of information and the high quality, by adopting such the method therein, in particular, within the optical disk apparatus enabling to record/reproduce information also onto/from an optical information recording medium (the optical disk), adopting the so-called the verify process therein, for recording data onto both the Land and the Groove, as well as, maintaining the high-speed recording and the reliability (high quality), an object thereof is to provided.

While we have shown and described several embodiments in accordance with our invention, it should be understood that disclosed embodiments are susceptible of changes and modifications without departing from the scope of the invention. Therefore, we don not intend to be bound by the details shown and described herein but intend to cover all such changes and modifications that fall within the ambit of the appended claims.

What is claimed is:

1. An optical disk apparatus, for recording/reproducing information onto/from an optical disk, which forms a track made of spiral-like land and groove on a information recording surface thereof, and is executed with a verify process for a defect block within a user data recording area thereof, comprising:
a disk motor, which is configured to rotationally drive the optical disk;
a disk motor driver circuit, which is configured to drive said disk motor;
an optical pickup, which is configured to have a laser light source, for irradiating a light upon the recording surface of said optical disk being rotationally driven by said disk motor, and to receive a reflection light thereupon, and thereby recording or reproducing data on the recording surface of said optical disk;
a laser driver circuit, which is configure to drive the laser light source of said optical pickup;
a slide motor, which is configured to move said optical pickup into a radial direction on said optical disk;
a β value detector circuit, which is configured to detect a β value to determine an intensity of the light irradiated from said optical pickup; and
a controller, which is configured to control at least said disk motor driver circuit, said slide motor driver circuit and said laser driver circuit, upon basis of a signal from said optical pickup and said β value detector circuit, wherein
said controller obtains error information of the data, which is written by the light irradiated from said optical pickup, from a reproduced signal, which is reproduced by said optical pickup, and also compensates the intensity of the light irradiated from the laser light source of said optical pickup, upon basis of the β value and the error information, which are detected when a verify process is conducted.

2. The optical disk apparatus, as described in the claim 1, wherein said controller obtains said β value and said error information, for each of said land and said groove, respectively, and also compensates the intensity of the light irradiated from the laser light source of said optical pickup, for each of said land and said groove, respectively.

3. The optical disk apparatus, as described in the claim 1, wherein said controller obtains statistic information thereof from said β value obtained, and compensates the intensity of the light, which is irradiated from the laser light source of said optical pickup, upon basis of said statistic information.

4. The optical disk apparatus, as described in the claim 3, wherein said controller obtains said statistic information through an averaging process of the β value obtained.

5. The optical disk apparatus, as described in the claim 1, wherein said controller compensates the intensity of the light, which is irradiated from the laser light source of said optical pickup, by changing said β value.

6. A method for compensating a recording power of an optical disk apparatus, for recording/reproducing information onto/from an optical disk, which forms a track made of spiral-like land and groove on a information recording surface thereof, and is executed with a verify process for a defect block within a user data recording area thereof, wherein
when executing a verify process, error information of data, which is written by a light irradiated from an optical pickup, is obtained from a reproduced signal, which is reproduced from said optical pickup, and an intensity of the light irradiated from a laser light source of said optical pickup, upon basis of a β value and the error information, which are detected when executing said verify process.

7. The method for compensating a recording power of an optical disk apparatus, as described in the claim 6, wherein said β value and said error information are obtained for each of said land and said groove, respectively, and the intensity of the light irradiated from the laser light source of said optical pickup is compensated for each of said land and said groove, respectively.

8. The method for compensating a recording power of an optical disk apparatus, as described in the claim 6, wherein statistic information thereof is obtained from said β value obtained, and the intensity of the light, which is irradiated from the laser light source of said optical pickup is compensated, upon basis of said statistic information.

9. The method for compensating a recording power of an optical disk apparatus, as described in the claim 8, wherein said statistic information is obtained through an averaging process of the β value obtained.

10. The method for compensating a recording power of an optical disk apparatus, as described in the claim 6, wherein the intensity of the light, which is irradiated from the laser light source of said optical pickup, is compensated, by changing said β value.
